(19) United States
(12) Patent Application Publication
(10) Pub. No.: US 2007/0059672 A1
(43) Pub. Date: Mar. 15, 2007

(54) Nutrition tracking systems and methods

(76) Inventor: Matthew Shaw, Newnan, GA (US)

Correspondence Address: PAPARELLA & ASSOCIATES, PLC, 930 N. WASHINGTON AVE., LANSING, MI, 48906, US

(21) Appl. No.: 11/224,468

(22) Filed: Sep. 12, 2005

(51) Int. Cl. G09B 19/00; G06F 1/16

(52) U.S. Cl. 434/127; 708/100

(57) ABSTRACT

A method for a user to track nutrition information includes: scanning a plurality of nutrition codes corresponding to a plurality of respective food items via a scanning device, wherein each of said plurality of nutrition codes corresponds to nutrition information for each of said plurality of respective food items; consuming substantially all of said plurality of respective food items; and viewing aggregated nutrition information corresponding to said plurality of respective food items.

### BACKGROUND

Existing systems and methods provide nutritional information on a food container which contains the food that is consumed. However, these systems and methods do not provide a way to conveniently and accurately track aggregate nutritional information of the food consumed. Therefore, there exists a need for systems and methods that address these and/or problems associated with existing nutrition tracking systems.

### SUMMARY

Systems and methods for tracking nutrition information are provided. A method for a user to track nutrition information includes: scanning a plurality of nutrition codes corresponding to a plurality of respective food items via a scanning device, wherein each of said plurality of nutrition codes corresponds to nutrition information for each of said plurality of respective food items; consuming substantially all of said plurality of respective food items; and viewing aggregated nutrition information corresponding to said plurality of respective food items.

A method for using a nutrition tracking device includes: scanning a plurality of nutrition codes corresponding to a plurality of respective food items via a scanning device, wherein each of said plurality of nutrition codes corresponds to nutrition information for each of said plurality of respective food items; aggregating nutrition information corresponding to said plurality of respective food items; and displaying aggregated nutrition information corresponding to said food items contained in said plurality of food containers.

A nutrition tracking device includes: a scanning component configured to scan a plurality of nutrition codes corresponding to a plurality of respective food items, wherein each of said plurality of nutrition codes corresponds to nutrition information for each of said plurality of respective food items; memory configured to store said nutrition information corresponding to each of said plurality of nutrition codes responsive to said scanning component scanning said nutrition codes; logic configured to aggregate said nutrition information corresponding to each of said plurality of nutrition codes; and a display component configured to display said nutrition information aggregated by said logic.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a block diagram depicting a nutrition tracking system according to an embodiment of the invention, among others

FIG. 1B is a block diagram depicting a nutrition tracking device according to an embodiment of the invention, among others.

FIG. 2 is a flow chart depicting a method for using a nutrition tracking system according to an embodiment of the invention, among others.

FIG. 3 is a flow chart depicting a method that may be implemented by a nutrition tracking device according to an embodiment of the invention, among others.

FIG. 4 is a schematic diagram depicting a nutrition label according to an embodiment of the invention, among others.

FIGS. 5A-5C are schematic diagrams depicting a nutrition tracking device according to an embodiment of the invention, among others.

FIG. 6 is a schematic diagram depicting nutrition information on an output display according to an embodiment of the invention, among others.

FIG. 7 is a schematic diagram depicting food items consumed on an output display according to an embodiment of the invention, among others.

FIG. 8 is a flow chart depicting a method implemented by a nutrition tracking system to alert a user when a predetermined calorie consumption is exceeded according to an embodiment of the invention, among others.

FIG. 9 is a flow chart depicting a method implemented by a nutrition tracking system to alert a user when a predetermined fat consumption is exceeded according to an embodiment of the invention, among others

FIG. 10 is a flow chart depicting a method implemented by a nutrition tracking system to alert a user when a predetermined carbohydrate consumption is exceeded according to an embodiment of the invention, among others

### DETAILED DESCRIPTION OF THE PREFERRED EMBODIMENTS

According to an embodiment of the invention, a nutrition tracking device may comprise a case of varying sizes and shapes, a screen to display numbers and text, a scanner, a scanner activation button, logic to aggregate data, and memory to store data. Additionally, the nutrition tracking device may comprise a wireless interface to a remote server for storage. The screen may be similar to that of a wireless text pager or a cell phone. The scanner is configured to scan nutrition codes located on a food container, inside a food container, or on a food item itself. A user may activate the scanner by pressing the activation button and then the user may scan the nutrition code. The nutrition code may contain nutrition information of the food item such as, for example, calories, fat, carbohydrates, protein, cholesterol, sodium, potassium, caffeine and/or vitamins (e.g., A, B, C, etc.). The nutrition information would be stored in the memory of the nutrition tracking device or remotely via a wireless interface to a remote server. The logic of the nutrition tracking device may aggregate the nutrition information over a predetermined time period (e.g., day, week, month, etc.). For example, one function of the nutrition tracking device may be to track the calories consumed over a day.

Any food item may contain a nutrition code. For example, a fast food restaurant may provide food in an individualized one serving package containing a nutrition code on the package. The nutrition code would comprise all the nutrition information corresponding to the food contained in the package. For example, McDonald's may include a nutrition code on items it serves such as on a Big Mac wrapper, a French fry container, and a cola drink cup. A user may purchase these items, scan the nutrition codes on the food container, and consume the food items. The nutrition tracking device is configured to automatically store the nutrition information corresponding to the food items.

The nutrition tracking device is configured to display nutrition information on a screen. The screen may continuously display nutrition information responsive to a user's input such as, for example, the overall calorie consumption for the current day. Additionally, other information may be displayed such as, for example, time, date, etc. The nutrition tracking device may allow a user to view stored nutrition information such as, for example, daily, weekly, and monthly nutrition information. The nutrition tracking device may comprise a scrolling wheel and/or alphanumeric keys for a user to access the nutrition information or it may comprise a voice activation and response system.

The nutrition tracking device may be configured to allow a user to enter nutritional limits and to alert the user when the nutritional limits are approaching, reached, and exceeded. For example, a user may desire to limit daily caloric intake to 2,500 calories and fat intake to 20 grams per day. The nutrition tracking device may be configured to alert the user of these limits. An alert may be, for example, a sound or silent vibration. The alert could be set for any of the nutrition information tracked by the nutrition tracking device. Additionally, the nutrition tracking device may be configured to alert the user if a certain nutrition value is not reached. For example, a user may desire to consume 200 grams of protein by 4 pm each day. The device may alert the user as 4 pm approaches if the user is below 200 grams of protein for that day.

The nutrition tracking device may also track nutrition codes from foods that come from a grocery store. For example, foods such as meat, poultry, bread, ice cream, etc. typically come in a package with several servings. The nutrition code on these food items may contain nutrition information corresponding to one serving size. For example, a user may have 2.5 cups of cereal, but the serving size may be 1 cup. The nutrition tracking device may be configured to allow a user to scan the nutrition code on the cereal corresponding to a serving size of 1 cup and then to use the input on the nutrition tracking device to enter 2.5 servings. Additionally, the nutrition tracking device may connect to an internal or external database either directly via a local connection (e.g., RS232, USB, and Ethernet) or via a wireless connection (e.g., WIFI). The database would allow for input of commonly eaten food items, odd sized food items, and food items without a nutrition code. A user may input a food without a nutrition code and connect to the database to download the corresponding nutrition information. For example, a user may input a banana into the nutrition tracking device and the device may connect to the database and download nutrition information corresponding to a banana. The database would also allow external storage of the nutrition information in the nutrition tracking device. For example, the nutrition tracking device may be synchronize with the user's personal computer with corresponding software to store, print, view, and analyze nutrition information.

The nutrition tracking device may be contained in a case similar, for example, to a text pager. The case may be sized to fit on a key chain such as, for example, a key fob. Additionally, the functionality of the nutrition tracking device may be added to other devices such as a cell phone, a personal computer, or a PDA with the addition of a scanning device.

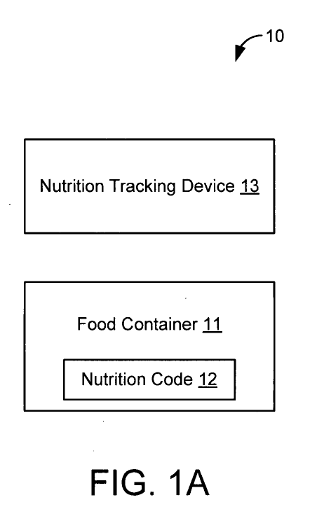

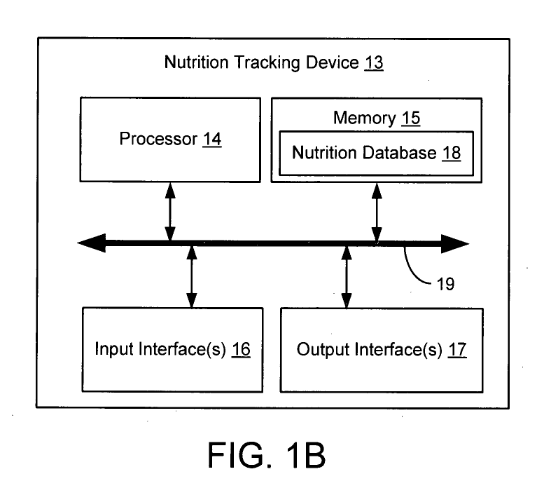

Referring now to the drawings, FIG. 1A is a block diagram depicting a nutrition tracking system 10 according to an embodiment of the invention, among others. The nutrition tracking system 10 comprises a food container 11, a nutrition code 12, and a nutrition tracking device 13. The nutrition-tracking device 13 is configured to store a plurality of nutrition codes 12 located on a plurality of food containers 11. In one example, the nutrition code 12 may be contained on a bar code or another code suitable for scanning located on the food container 11. In another example, the nutrition code 12 may be located inside the food container 11. In a third example, the nutrition code 12 may be located in a table of nutrition information located on the food container 11, and the nutrition information may be manually entered via a user on the nutrition tracking device 13. The nutrition code 12 corresponds to nutrition information (e.g., calories, carbohydrates, fat, protein, cholesterol, etc.) for food contained in the food container(s) 11.

FIG. 1B is a block diagram depicting a nutrition tracking device 13 according to an embodiment of the invention, among others. The nutrition tracking device 13 comprises a processor 14, memory 15, an input device(s) 16, and an output interface(s) 17. These components (14, 15, 16, and 17) are communicatively coupled via a local interface 19. The local interface 19 can be, for example but not limited to, one or more buses or other wired or wireless connections, as is known in the art. The local interface 19 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 14 can be any custom made or commercially available processor, a central processing unit (CPU), a semiconductor-based microprocessor (in the form of a microchip or chip set), or generally any device for executing software instructions. When the nutrition tracking system 13 is in operation, the processor 14 is configured to execute software stored within the memory system 15, to communicate data to and from the memory system 15, and to generally control operations of the nutrition tracking system 13 pursuant to the software. For example, the processor 14 may be configured to aggregate nutrition information based on a user input.

The memory 15 may comprise, for example, any one or combination of volatile memory elements (e.g., random access memory (RAM, such as DRAM, SRAM, SDRAM, etc.)) and nonvolatile memory elements (e.g., ROM, hard drive, tape, CDROM, etc.). The memory 15 is configured to store the nutrition information in a nutrition database 18 and the executable instructions of the nutrition tracking device 13. Additionally, the memory 15 may comprise external storage in a separate device such as a personal computer.

The input interfaces(s) 16 may be used to receive user input and/or nutrition information. The input device(s) 16 may comprise, for example, a scanner configured to scan a nutrition code 12 and/or a keyboard for manual data input. The output interface(s) 17 may be used to display nutrition information and/or to provide data to an external device (e.g., computer, printer, etc.). The output device(s) 17 may comprise, for example, a liquid crystal display (LCD) screen, a universal serial bus (USB) connection to a computer, or any other computer synchronization device, among others.

The nutrition tracking device 13 may be contained as a stand alone device, personal computer (PC), personal digital assistant (PDA), or cell phone, among others. The nutrition tracking device 13 in a stand alone device may comprise a portable case resembling a cell phone, pager, or PDA. Additionally, the nutrition tracking device 13 may be contained in a small case which may attach to a key chain such as, for example, a key chain fob. The nutrition tracking device 13 may be contained in an existing device such as a cell phone, pager, personal digital assistant (PDA), or computer.

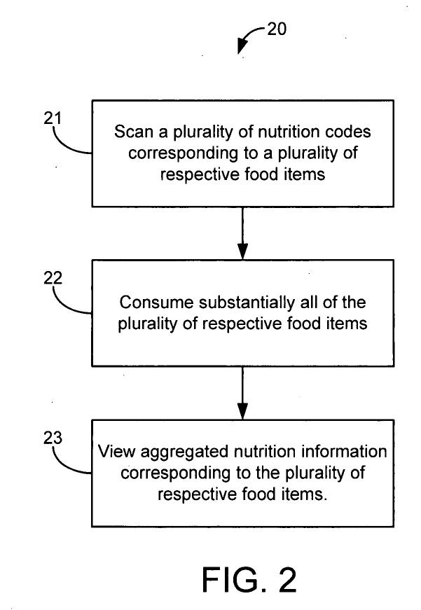

FIG. 2 is a flow chart depicting a method 20 for using a nutrition tracking system 10 according to an embodiment of the invention, among others. A plurality of nutrition codes corresponding to a plurality of respective food items are scanned, as indicated in step 21. The nutrition code comprises nutrition information for a respective food item such as, for example, calories, carbohydrates, fat, protein, cholesterol, and sodium. The nutrition code may be contained on a food container, inside a food container, or on a food item itself. For example, a nutrition tracking device 13 may be configured to scan the respective nutrition code on a plurality of food items and to store the respective nutrition information corresponding to the nutrition code. A user consumes substantially all of the plurality of respective food items, as indicated in step 22. The user views aggregated nutrition information corresponding to the plurality of respective food items, as indicated in step 23. For example, the nutrition tracking device 13 may aggregate the nutrition information for a predetermined or user-specified time period. Additionally, the nutrition tracking device 13 may comprise a display to show the aggregated nutrition information.

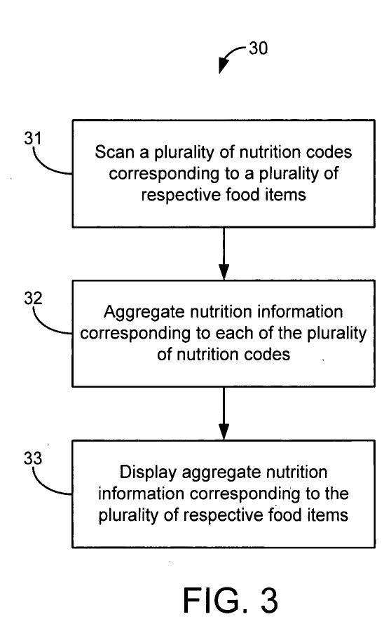

FIG. 3 is a flow chart depicting a method 30 that may be implemented by a nutrition tracking device 13 according to an embodiment of the invention, among others. A plurality of nutrition codes corresponding to a plurality of respective food items are scanned, as indicated in step 31. The nutrition code comprises nutrition information for a respective food item such as, for example, calories, carbohydrates, fat, protein, cholesterol, and sodium. The nutrition code may be contained on a food container, inside a food container, or on a food item itself. For example, the nutrition tracking device 13 may be configured to scan the respective nutrition code on a plurality of food items and to store the respective nutrition information corresponding to the respective nutrition code. The nutrition information corresponding to each of the plurality of nutrition codes is aggregated, as indicated in step 32. For example, the nutrition tracking device 13 may be configured to aggregate the nutrition information for a predetermined or user-specified time period. The aggregate nutrition information corresponding to the plurality of respective food items is displayed, as indicated in step 33. Additionally, the nutrition tracking device may comprise a display to show the aggregated nutrition information.

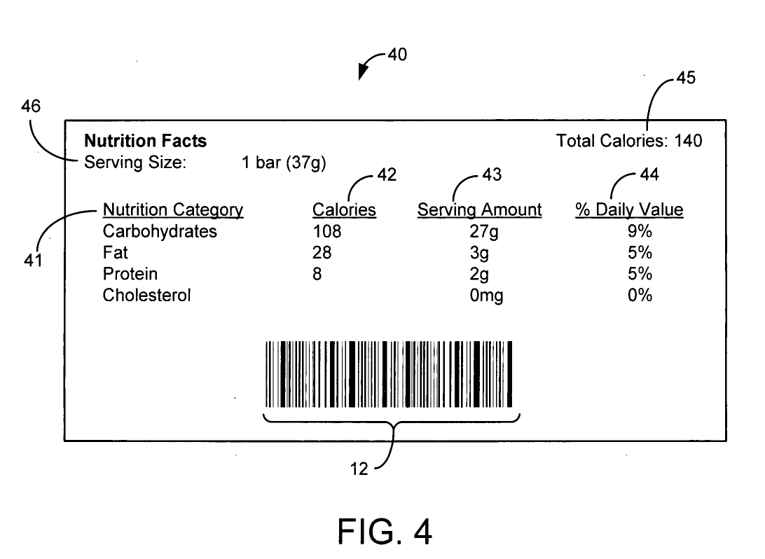

FIG. 4 is a schematic diagram depicting a nutrition label 40 according to an embodiment of the invention, among others. The nutrition label 40 may comprise a nutrition code 12, nutrition categories 41, calories 42, a serving amount 43, percent of daily value 44, total calories 45, and a serving size 46. The serving size 46 provides the amount of food corresponding to the information provided in the nutrition label 40. The nutrition categories 41 may comprise, for example, carbohydrates, fat, protein, and cholesterol. The calories 42 comprise the amount of calories in each nutrition category 41 included in the serving size 46 of the food. In this example, the listing of calories 42 provides the carbohydrate calories of 120 and the fat calories of 20 for the serving size 46. The serving amount 43 comprises the amount of each nutrition category 41 included in the serving size 46 of the food. The percent of daily value 44 comprises the recommended amount of each nutrition category 41 per the United States Department of Agriculture (USDA) guidelines. The nutrition label 40 may comprise a nutrition code 12 which may contain the nutrition information in the nutrition label 40. The nutrition code 12 may be a bar code or any other code suitable for scanning. For example, the nutrition tracking device 13 may comprise a scanner to scan the nutrition code 12. The total calories 45 comprises the aggregate calories for each nutrition category 41 in the serving size 46.

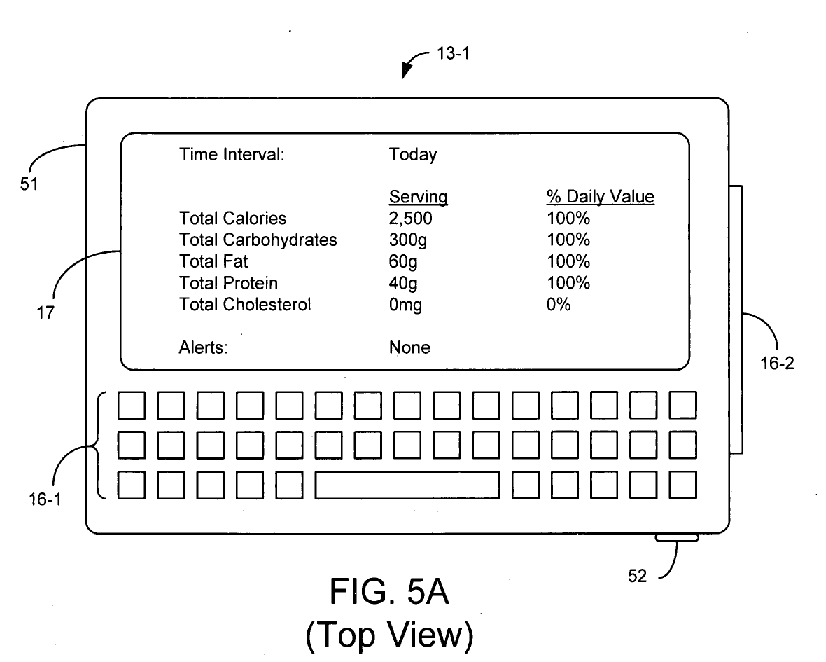

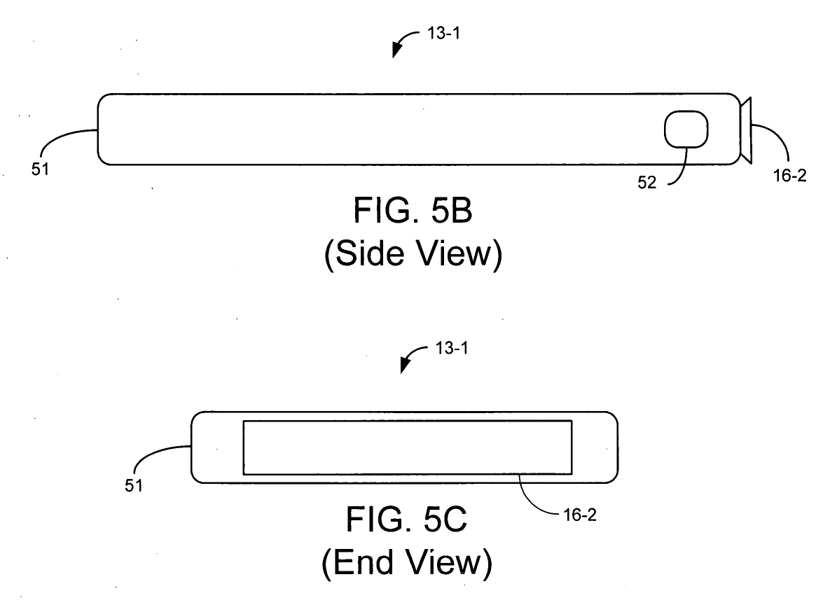

FIGS. 5A-5C are schematic diagrams depicting a nutrition tracking device 13-1 according to an embodiment of the invention, among others. The nutrition tracking device 13-1 may comprise a case 51, an output display 17, an input keyboard 16-1, and a scanner 16-2. The output display 17 is configured to display nutrition information. The output display 17 may be, for example, a liquid crystal display (LCD). The input keyboard 16-1 is configured to input nutrition information and to allow the user to control the nutrition tracking device 13-1. The scanner 16-2 is configured to scan a nutrition code 12. The input scanner 16-2 is activated by pressing an activation button 52 which may be, for example, located on the case 51. The scanner 16-2 may comprise, for example, a light emitter and a light receiver to scan the nutrition code 12.

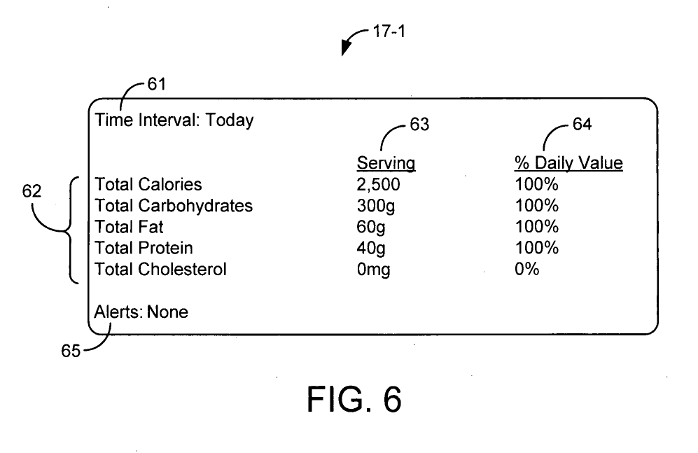

FIG. 6 is a schematic diagram depicting an output display 17-1 that shows an example of nutrition information according to an embodiment of the invention, among others. The output display 17-1 may be contained on a nutrition tracking device 13. In this example, the output display 17-1 displays a time period 61, nutrition categories 62, a serving amount 63, a percent of daily value 64, and an alert banner 65. The time period 61 indicates the time period (e.g., today, current week, etc.) corresponding to the nutrition information. The nutrition categories 62 may comprise, for example, calories, carbohydrates, fat, protein, and cholesterol. The serving amount 63 corresponds to the amount of each item in the nutrition categories 62 contained in the food consumed in the time period 61. The percent of daily value 64 corresponds to the recommended percentage of the nutrition categories 62 contained in the food consumed in the time period 61. The alert banner 65 may be, for example, configured to display alerts responsive to a predetermined threshold for a particular nutrition category. For example, the alert banner 65 may alert a user when a certain carbohydrate threshold is met for a time period if the user is on a low carbohydrate diet. The nutrition-tracking device 13-1 may be configured to enable the display of other aggregated nutrition information (e.g., vitamins and minerals). Furthermore, the nutrition-tracking device 13-1 may be configured to display nutrition information corresponding to user-defined time periods (e.g. week, months, etc.) as well as displaying user-defined nutrition information.

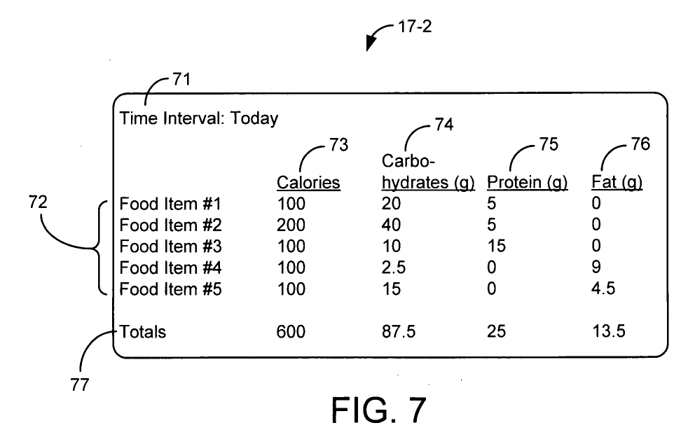

FIG. 7 is a schematic diagram depicting an output display 17-1 that shows an example list of food items according to an embodiment of the invention, among others. The output display 17-1 may be contained on a nutrition tracking device 13. In this example, the output display 17-1 displays a time period 71, a food item list 72, calories 73, carbohydrates 74, protein 75, fat 76, and an aggregate total 77. The time period 71 indicates the time period (e.g., today, current week, etc.) in which the food item list 72 was consumed. The listings (73, 74, 75, and 76) provide the values corresponding to the quantities in each of the food items in the food item list 72. The aggregate total 77 sums each of the quantities in the listings (73, 74, 75, and 76). The nutrition tracking device 13 may be configured to enable the display of other aggregated nutrition information (e.g., vitamins and minerals, calories, etc.) over set or user-defined time periods.

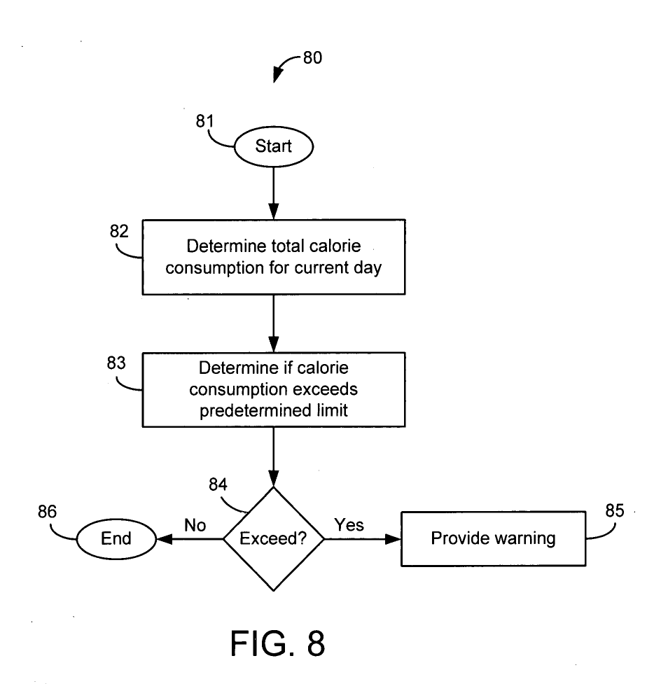

FIG. 8 is a flow chart depicting a method 80 implemented by a nutrition tracking system 13 to alert a user when a predetermined calorie consumption is exceeded according to an embodiment of the invention, among others. The method 80 comprises starting (step 81); determining the total calorie consumption for the current day (step 82); and determining if the calorie consumption has exceeded the predetermined limit (step 83). A nutrition tracking device 13 determines if the consumption is exceeded (step 84). If the calorie consumption has been exceeded, then provide a warning (e.g., visible, audible, or tactile alert on the nutrition tracking device 13). If the calorie consumption has not been exceeded, then end (step 86).

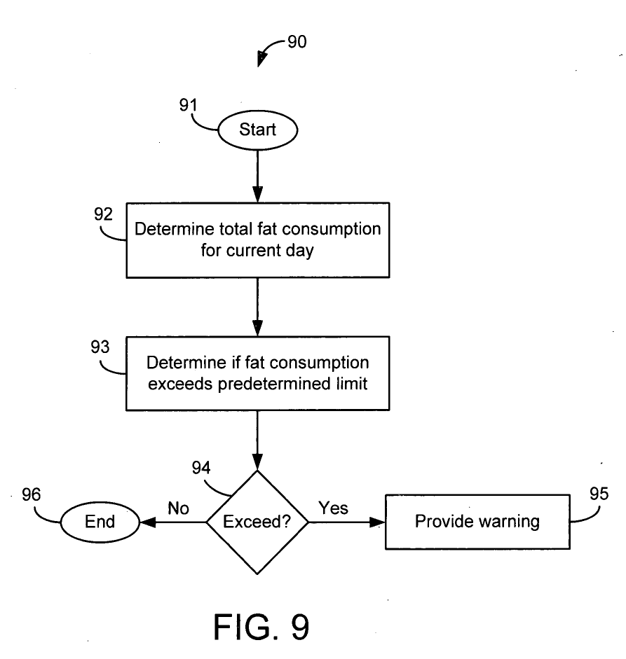

FIG. 9 is a flow chart depicting a method 80 implemented by a nutrition tracking system 13 to alert a user when a predetermined fat consumption is exceeded according to an embodiment of the invention, among others. The method 90 comprises starting (step 91); determining the total fat consumption for the current day (step 92); and determining if the fat consumption has exceeded the predetermined limit (step 93). A nutrition tracking device 13 determines if the consumption is exceeded (step 94). If the fat consumption has been exceeded, then provide a warning (e.g., visible, audible, or tactile alert on the nutrition tracking device 13). If the fat consumption has not been exceeded, then end (step 96).

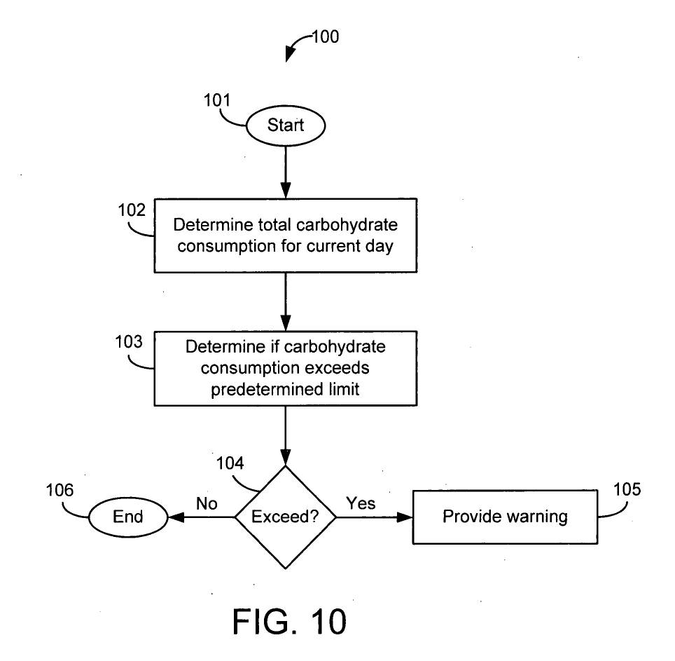

FIG. 10 is a flow chart depicting a method 80 implemented by a nutrition tracking system 13 to alert a user when a predetermined carbohydrate consumption is exceeded according to an embodiment of the invention, among others. The method 100 comprises starting (step 101); determining the total carbohydrate consumption for the current day (step 102); and determining if the carbohydrate consumption has exceeded the predetermined limit (step 103). A nutrition tracking device 13 determines if the consumption is exceeded (step 104). If the carbohydrate consumption has been exceeded, then provide a warning (e.g., visible, audible, or tactile alert on the nutrition tracking device 13). If the carbohydrate consumption has not been exceeded, then end (step 106). The methods 80, 90, and 100 may be implemented with other nutrition information (e.g., cholesterol, vitamins, and minerals) which is tracked by the nutrition tracking device 13.

It should be emphasized that the above-described embodiments of the present invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention.

1. A method comprising:
scanning a plurality of nutrition codes corresponding to a plurality of respective food items via a scanning device, wherein each of said plurality of nutrition codes corresponds to nutrition information for each of said plurality of respective food items;
consuming substantially all of said plurality of respective food items; and
viewing aggregated nutrition information corresponding to said plurality of respective food items.

2. The method of claim 1, wherein said aggregated nutrition information is displayed by said scanning device.

3. The method of claim 1, wherein said nutrition information comprises the quantity contained in a food item of one or more of calories, carbohydrates, fat, protein, cholesterol, potassium, sodium, caffeine, vitamin A, vitamin B, and vitamin C.

4. The method of claim 1, wherein said nutrition code is contained on at least one of a food container and a food item.

5. The method of claim 4, wherein said nutrition code comprises a bar code.

6. The method of claim 2, wherein said scanning device is configured to:
scan said plurality of nutrition codes;
store said nutrition information in memory;
aggregate said nutrition information corresponding to a user specified time period and a predetermined time period;
display said aggregated nutrition information to a user; and
alert said user to a user specified threshold of said nutrition information.

7. A method comprising:
scanning a plurality of nutrition codes corresponding to a plurality of respective food items via a scanning device, wherein each of said plurality of nutrition codes corresponds to nutrition information for each of said plurality of respective food items;
aggregating nutrition information corresponding to said plurality of respective food items; and
displaying aggregated nutrition information corresponding to said food items contained in said plurality of food containers.

8. The method of claim 7, wherein said aggregated nutrition information is displayed by said scanning device.

9. The method of claim 7, wherein said nutrition information comprises the quantity contained in a food item of one or more of calories, carbohydrates, fat, protein, cholesterol, potassium, sodium, vitamin A, vitamin B, and vitamin C.

10. The method of claim 7, wherein said nutrition code is contained on at least one of a food container and a food item.

11. The method of claim 10, wherein said nutrition code comprises a bar code.

12. The method of claim 8, wherein said scanning device is configured to:
scan said plurality of nutrition codes;
store said nutrition information;
aggregate said nutrition information corresponding to a user specified time period and a predetermined time period;
display said aggregated nutrition information to a user; and
alert said user to a user specified threshold of said nutrition information.

13. The method of claim 7, further comprising:
setting a threshold value of said aggregated nutrition information; and
alerting a user when said threshold value is approaching, is met, and is exceeded.

14. The method of claim 13, wherein an alert comprises at least one of a sound, a display notification, and a silent vibration.

15. A nutrition tracking device comprises:
a scanning component configured to scan a plurality of nutrition codes corresponding to a plurality of respective food items, wherein each of said plurality of nutrition codes corresponds to nutrition information for each of said plurality of respective food items;
memory configured to store said nutrition information corresponding to each of said plurality of nutrition codes responsive to said scanning component scanning said nutrition codes;
logic configured to aggregate said nutrition information corresponding to each of said plurality of nutrition codes; and
a display component configured to display said nutrition information aggregated by said logic.

16. The nutrition tracking device of claim 15, further comprising an input interface of at least one of alphanumeric input keys, a QWERTY keyboard, predefined buttons, and a scroll wheel.

17. The nutrition tracking system of claim 15, further comprising an output interface of at least one of a universal serial bus (USB) connector, a WIFI wireless networking connection, and a serial RS232 connector.
